(19) United States
(12) Patent Application Publication
(10) Pub. No.: US 2010/0176339 A1
(43) Pub. Date: Jul. 15, 2010

(54) Jewelry having titanium boride compounds and methods of making the same

(76) Inventor: K.S. Ravi Chandran, Salt Lake City, UT (US)

Correspondence Address: THORPE NORTH & WESTERN, LLP., P.O. Box 1219, SANDY, UT, 84091-1219, US

(21) Appl. No.: 12/352,477

(22) Filed: Jan. 12, 2009

(51) Int. Cl. C09K 3/00; C01B 35/04; D21B 1/04

(52) U.S. Cl. 252/182.33; 423/297; 264/115

(57) ABSTRACT

An article of jewelry can include a main body can comprise or consist essentially of a titanium boride. The main body can be a titanium boride such as titanium monoboride, titanium diboride, ternary boride, or quaternary boride. Additionally, a method of forming an article of jewelry having a titanium boride microstructure can include forming a powder precursor of a predetermined shape corresponding to a desired jewelry shape, growing titanium boride microstructure from the powder precursor to form a titanium boride main body, recovering the titanium boride main body, and finishing the recovered titanium boride main body into the jewelry shape.

### BACKGROUND OF THE INVENTION

Jewelry is generally used as an ornament on the body or as a decorative item to improve the aesthetics, beauty, and intrinsic worth of an item. As an ornament, jewelry is generally worn on the body, such as rings, earrings, necklaces, bracelets, etc. As a decorative item, jewelry has been generally displayed with high-value items, such as artistic pieces. In such cases, jewelry may take the form of a frame or handle. Furthermore, the use of jewelry in personal and functional items, such as cell-phones, watches, glasses, guns and pistols, pens, faucets, fixtures, etc is becoming more common. Generally, personal items have frequent contact with body parts, such as hands, and are subject to a more “wear and tear” than other jewelry items. However, jewelry used with functional fixtures can also be exposed to considerable wear and tear.

### SUMMARY OF THE INVENTION

As such, it has been recognized that jewelry articles that are durable and can sustain long life would be desirable. Common precious metal-based alloys (for example, silver, gold and platinum alloys) have poor mechanical properties such as yield strength, hardness, wear and scratch resistance. Furthermore, with the use of jewelry in personal items, such as cell-phones, watches etc, various physical and mechanical properties of precious metals have become more critical for the durability of jewelry products. Additionally, precious metal based jewelry can command considerable cost. It has therefore been recognized that high strength, hardness, corrosion and erosion resistance, wear and scratch resistance, and affordable cost in such products is greatly desired. For this and other reasons, the need remains for methods and materials which can provide new or improved articles of jewelry and avoid the drawbacks mentioned above.

It would therefore be advantageous to develop improved materials and methods which produce an article of jewelry having improved strength, hardness, corrosion and erosion resistance, wear and scratch resistance. The present invention provides methods and materials for jewelry having micro structured, and even nanostructured, titanium borides, including titanium monoboride (TiB), which satisfies many of the above criteria.

In one aspect of the present invention, an article of jewelry can include a main body consisting essentially of titanium boride. Additionally, the main body can be formed of monolithic titanium monoboride whiskers where the monolithic titanium monoboride whiskers are present at a volume content greater than about 80% of the main body and the article is substantially free of titanium diboride.

In another aspect of the present invention, an article of jewelry can include a main body comprising a majority of a boride compound selected from the group consisting of titanium monoboride, titanium diboride, a ternary boride, and mixtures thereof. Alternatively, the main body can be substantially free of titanium diboride.

In another aspect of the present invention, an article of jewelry can include a main body comprising a titanium boride including titanium monoboride in a volume percent of about 30% to about 80%. In another aspect, an article of jewelry can include a main body consisting essentially of a titanium boride including titanium monoboride in a volume percent of about 30% to about 80%. The present invention also provides methods of forming such articles of jewelry. In one aspect, a method of forming an article of jewelry having a titanium boride microstructure can include forming a powder precursor including a titanium source powder and boride source powder. The powder precursor can be prepared to have a predetermined shape corresponding to a desired jewelry shape. A titanium boride microstructure can be grown from the powder precursor to form a titanium boride main body. The titanium boride main body can then be recovered and finished into a final jewelry shape.

Additional features and advantages of the invention will be apparent from the following detailed description, which illustrates, by way of example, features of the invention.

### BRIEF DESCRIPTION OF THE DRAWINGS

FIG. 1 is an illustration of a bi-modal size distribution of powder particles in the powder precursor in accordance with one embodiment of the present invention.

FIG. 2 is an illustration of a tri-modal size distribution of powder particles in the powder precursor in accordance with one embodiment of the present invention.

FIG. 3 is an illustration of a tri-modal size distribution of powder particles in the powder precursor having two different sizes of titanium particles in accordance with one embodiment of the present invention.

FIGS. 4A and 4B illustrate the microstructure of the nanostructured titanium boride made with the powder composition of Ti—TiB₂—FeMo: 157-159-15 (grams) magnified at 1000× and 2000×, respectively, in accordance with an embodiment of the present invention.

FIGS. 5A and 5B illustrate the microstructure of the nanostructured titanium boride with the composition of Ti—TiB₂—FeMo: 135-159-15 (grams), magnified at 1000× and 2000×, respectively, in accordance with an embodiment of the present invention.

FIG. 6 is a graph of strength distribution for nanostructured titanium boride materials made with different compositions of powders, which are listed in Table 1, in accordance with several embodiments of the present invention.

FIG. 7 is a graph of strength and hardness variation in the nanostructured titanium boride as a function of the titanium content in the powder mixture for samples listed in Table 1 in accordance with several embodiments of the present invention.

FIG. 8 illustrates actual load-displacement traces of the flexural strength tests for the composition of Ti—TiB₂—FeMo: 157-159-15 (grams) (SM 11) in accordance with an embodiment of the present invention.

FIGS. 9A and 9B are optical pictures of microstructures for nanostructured titanium boride made with a powder composition of Ti—TiB₂—FeMo: 157-159-15 (grams); (a) at 200× and (b) at 1000× in accordance with an embodiment of the present invention.

FIG. 10A shows a micrograph of a titanium monoboride material in accordance with an embodiment of the present invention.

FIG. 10B shows a micrograph of the titanium monoboride material of FIG. 10A at a higher magnification.

FIG. 11 is graph of stress versus extension in load displacement results of eight different titanium monoboride articles in bending flexure tests for the material shown in FIGS. 10A and 10B.

FIG. 12 is graph of stress versus extension in load displacement results of eight different commercial titanium diboride articles in bending flexure tests.

FIG. 13 is a graph of cumulative failure probabilities versus fracture stress for titanium monoboride articles of the present invention and several commercial titanium diboride samples which highlight the contrast in increased strength in the titanium monoboride.

It should be noted that the figures are merely exemplary of several embodiments of the present invention and no limitations on the scope of the present invention are intended thereby.

### DETAILED DESCRIPTION

Reference will now be made to exemplary embodiments and specific language will be used herein to describe the same. It will nevertheless be understood that no limitation of the scope of the invention is thereby intended. Alterations and further modifications of the inventive features described herein, and additional applications of the principles of the invention as described herein, which would occur to one skilled in the relevant art and having possession of this disclosure, are to be considered within the scope of the invention. Further, before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

### DEFINITIONS

In describing and claiming the present invention, the following terminology will be used.

The singular forms “a,” “an,” and “the” include plural references unless the context clearly dictates otherwise. Thus, for example, reference to “a powder precursor” includes reference to one or more of such materials, and “a densifier” includes reference to one or more of such materials.

As used herein, “titanium” without an accompanying element is intended to refer to elemental titanium in the zero oxidation state. Thus, terms such as “titanium powder” and “titanium” refer to elemental titanium and specifically exclude titanium compounds such as titanium diboride, titanium monoboride, etc.

As used herein, “whisker” refers to a microstructure and/or a nanostructure having a high aspect ratio, i.e. the length to diameter ratio greater than about 5:1. Typically, whiskers have a generally polygonal cross-section; however cross-sections may vary somewhat, e.g., hexagonal, diamond, and circular. Whisker diameters are most frequently in the nanometer range; however diameters can vary from about 50 nm to about 3 μm, although preferred diameters are from about 100 nm to about 600 nm.

As used herein, “nanostructure” is intended to indicate that at least one physical dimension of the crystal morphology is in the nanometer range, i.e. less than 1 μm, and preferably less than about 800 nm.

As used herein, “microstructure” is intended to indicate that all of the physical dimensions of the crystal morphology is in the micrometer range, i.e., less than 1 millimeter, and preferably less than 800 μm.

As used herein, “monolithic” refers to a material which can be formed or cast as a homogeneous single piece. Typically, monolithic materials have a relatively uniform composition throughout, i.e. substantially free of joints, layers or the like, although other materials can be subsequently joined thereto.

As used herein, “densifier” refers to a filler material which acts to increase density and decrease porosity of the article during the formation of the body. Typically, the densifier is an active material which not only contributes to packing efficiency but also facilitates and participates in whisker formation as described more fully herein.

As used herein, “near net shape” refers to an article of jewelry or part thereof that requires substantially no machining after formation of the article or part thereof to achieve the desired final or net shape. By “substantially no machining,” the article would require only polishing rather than significant grinding or material removal as is known in the art.

As used herein, “packing factor” refers to the ratio of volume occupied by solids to volume of a unit cell. Thus, a packing factor for mixtures of particles is independent of absolute size and is directly related to relative sizes. A packing factor of 1.0 would indicate 100% solid with no voids which is not achievable using spherical particles.

As used herein, “substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context. Similarly, “substantially free of” or the like refers to the lack of an identified element or agent in a composition. Particularly, elements that are identified as being “substantially free of” are either completely absent from the composition, or are included only in amounts which are small enough so as to have no measurable effect on the composition.

As used herein, “about” refers to a degree of deviation based on experimental error typical for the particular property identified. The latitude provided in the term “about” will depend on the specific context and particular property and can be readily discerned by those skilled in the art. The term “about” is not intended to either expand or limit the degree of equivalents which may otherwise be afforded a particular value. Further, unless otherwise stated, the term “about” shall expressly include “exactly,” consistent with the discussion below regarding ranges and numerical data.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a size range of about 1 μm to about 200 μm should be interpreted to include not only the explicitly recited limits of 1 μm and about 200 μm, but also to include individual sizes such as 2 μm, 3 μm, 4 μm, and sub-ranges such as 10 μm to 50 μm, 20 μm to 100 μm, etc.

Jewelry Articles

In accordance with the present invention, an article of jewelry can include a main body comprising or consisting essentially of titanium boride. The articles of jewelry described herein can be any piece of jewelry including rings, necklaces, watches, bracelets, chains, pendants, links, casings, parts thereof, combinations thereof, and sets thereof. In one aspect, an article of jewelry can include a main body comprising a majority of a boride compound selected from the group consisting of titanium monoboride, titanium diboride, a ternary boride, quaternary boride, and mixtures thereof. As such, the boride compound can be titanium diboride. Additionally, the boride compound can be a ternary boride. Also, the boride compound can be a quaternary boride. Further, the boride compound can be substantially free of titanium diboride. In another aspect of the present invention, an article of jewelry can include a main body comprising a titanium boride including titanium monoboride in a volume percent of about 30% to about 80%. Additionally, an article of jewelry can have a body comprising or consisting essentially of a titanium or a titanium alloy matrix inter-dispersed with a titanium monoboride phase; the titanium monoboride phase having a volume % from about 30% to about 80%.

The present invention refers to titanium borides. Generally, such titanium borides may include titanium monoboride, titanium diboride, titanium ternary borides, and titanium quaternary borides, mixtures thereof, and may include other titanium alloys or metals dispersed therein. Titanium monoboride (TiB) has one titanium atom for every boron (B) atom in the crystal unit cell of the body. Titanium diboride (TiB₂) has one titanium atom for every two B atoms in the crystal unit cell. The ternary and quaternary borides referred here are of the chemical stoichiometry: TiₓM_{y}B_{z} and Ti_{w}MₓN_{y}B_{z}, respectively, where M and N refer to substitutional transition metal atoms (examples: Fe, Mo, Ni, Al, Mg, Cr, Nb, V, W, Zr, Si etc.) and w, x, y and z refer to the numerical values of atomic fractions of the respective atoms in the equilibrium form of the crystal unit cell. Examples of ternary borides include TiFeB, TiMoB. An example of quaternary boride is TiFeMoB. Such varied formulations may occur between titanium boron and any one or more of the solid solution elements present in the matrix.

Referring now to titanium monoboride articles, although titanium boride jewelry articles containing greater than about 80% by volume of TiB whiskers can be beneficial, the titanium monoboride articles can be generally characterized by a high proportion of titanium monoboride whiskers or phases content. For example, in excess of 50% by volume of TiB, with the balance being a titanium alloy matrix containing one of more of Al, Mg, O, Fe, Ni, V, Nb, Mo, Cr, Sn, Zr, solid solution elements in the titanium matrix. These alloying elements can be introduced during manufacture to a level of anywhere from 0 to 30 wt %, either individually or in combination, to achieve optimum properties of the material for jewelry application. Some of the elements such as Al, Ni, Mg, Fe, Mo, V, Nb, Zr may be partially absorbed into the TiB, making the boride a ternary or quaternary boride.

In one aspect, the main body can be monolithic titanium monoboride whiskers. Generally, an article of jewelry having titanium monoboride can include a densely packed mass of titanium monoboride whiskers as a bulk monolithic material. The monolithic titanium monoboride whiskers can be present at a volume content greater than about 80% such that the primary constituent of the jewelry article is monolithic titanium monoboride whiskers which are intergrown and form an interconnected network of microstructure and/or nanostructure whiskers. Further, the main body of the jewelry articles of the present invention, as well as the articles themselves, can be substantially free of titanium diboride. The substantial elimination of titanium diboride from an article of jewelry can be achieved using the methods described in more detail below. In one aspect, the main body can consist essentially of the monolithic titanium monoboride whiskers and titanium. In a detailed aspect, the article can be completely free of titanium diboride.

The microstructure and/or nanostructure of the present invention is one important aspect which determines the beneficial extraordinary improvements in strength and mechanical properties of titanium monoboride embodiments. The volume content of monolithic titanium monoboride whiskers and the dimensions of such whiskers typically should fall within certain ranges in order to achieve the desired results. For example, although many monolithic titanium monoboride jewelry articles of the present invention containing greater than about 80% by volume of whiskers can be beneficial, the monolithic titanium monoboride jewelry articles are characterized by a high monolithic titanium monoboride whisker content. Typically, the titanium boride whisker volume content, e.g., monolithic titanium monoboride whisker volume content, can be from about 50% to about 100%, and can be from about 88% to about 97%. In one aspect the volume content can be at least 97%, or even at least 99%. In addition, the monolithic titanium monoboride whiskers can have a nanostructure wherein the average diameter of the monolithic titanium monoboride whiskers is from about 10 nm to about 900 nm, and preferably from about 20 nm to about 200 nm. It is thought that the whisker nanostructure and/or microstructure of these articles is largely responsible for the increase in mechanical strength. In one aspect, the article of jewelry can have a flexure strength from about 500 MPa to about 950 MPa. Typically, the titanium monoboride whiskers can have an average length of from about 1 μm to about 700 μm, and frequently from about 2 μm to about 300 μm. The length of the whiskers is sufficient to allow most of the titanium monoboride whiskers to form an interconnected network forming a monolithic material. In an additional related measure of the nanostructure, the monolithic titanium monoboride whiskers can have an average aspect ratio from about 5:1 to about 500:1, although other aspect ratios can be suitable.

In one aspect of the present invention, the article of jewelry can further include a densifier and other optional components. A densifier can typically comprise a minor amount of the final product and is most often in the range of 5 to 20 wt. %, preferably about 10%. In one aspect, the article of jewelry can consist essentially of monolithic titanium monoboride whiskers, densifier, and titanium.

In yet another aspect of the present invention, the article of jewelry can be electrically conductive. This electrical conductivity is relatively unique among ceramics. For example, ceramics such as silicon nitride or silicon carbide are not sufficiently conductive to allow machining via electrical discharge machining (EDM). Thus, such materials are usually machined using relatively expensive superabrasive tools such as diamond tools. In contrast, the microstructured and/or nanostructured monolithic titanium monoboride jewelry articles of the present invention can be readily machined using EDM such that highly complex or simple shapes can be formed without the need for expensive diamond tools. Although the articles of jewelry described herein can generally have a main body that is a near net shape, dramatic cutting and/or finishing steps can be readily accomplished using such EDM methods.

Exemplary Manufacturing Methods

The specific process and conditions for formation of the articles of jewelry of the present invention can be carefully chosen and implemented in order to achieve the microstructured and/or nanostructured titanium boride compounds described herein. In one aspect, a method of forming an article of jewelry having a titanium boride microstructure can include forming a powder precursor including a titanium source powder and boride source powder. The powder precursor is formed into a predetermined shape corresponding to a desired jewelry shape. The precursor can have a shape corresponding to jewelry such as, but not limited to, rings, necklace links, watch casings, watch links, bracelet links, chain links, pendants, casings, parts thereof, and combinations thereof. A titanium boride microstructure can be grown from the powder precursor under conditions sufficient to form a titanium boride main body. The titanium boride main body can be recovered and finished into the jewelry shape.

The boride material can have either a complex internal chemical constitution (ternary or quaternary boride) or phase mixture involving one or more of binary titanium borides such as TiB, Ti₃B₄ and TiB₂

Titanium Boride Articles from Bimodal Sized Source Powders

Suitable powder precursors include a titanium source powder and a boride source powder. In order to achieve the desired nanostructure and/or microstructure and optionally the absence of titanium diboride, the relative powder sizes and weight ratio are important. In addition, the powder precursor can have a titanium source powder to boride source powder weight ratio from about 0.8:1 to about 1.2:1. Weight ratios from about 0.9:1 to about 1.1:1 can also be used. However, currently preferred formulations of the powder precursor include a greater amount of boride source powder by weight such as about 0.95:1 to about 0.99:1, and most preferably about 0.96:1. A ratio of about 0.96:1 corresponds to a weight ratio of 49:51 when the powder precursor consists essentially of titanium powder and titanium diboride powder. Typically, weight ratios within about +/−2 wt % of the 49:51 ratio are preferred. These ratios can be adjusted to account for any substantial presence of other elements such as Zr, O, N, C, Fe, and the like.

In one aspect of the present invention, the article of jewelry having a titanium boride microstructure can have a titanium monoboride whisker nanostructure where the titanium source powder is titanium powder and the boride source powder is titanium diboride powder. The powder precursor can have a titanium powder to titanium diboride powder weight ratio from about 0.8:1 to about 1.2:1, and growing can be performed under conditions sufficient to grow monolithic titanium monoboride whiskers from the powder precursor, such that the monolithic titanium monoboride whiskers are substantially free of titanium diboride and are present at a volume content greater than about 80%.

As mentioned herein, the particle sizes of the respective powders can also govern the ability of the powder precursor to form nanostructured and/or microstructured titanium boride compounds, e.g., titanium monoboride, as well as can affect the process temperature and process time. Further, careful selection of relative powder sizes is important to achieve more uniform whisker growth and allow the extent of reaction to be driven to completion at the lowest possible process temperature. However, as a general guideline, the titanium source powder can have a particle size from about 5 μm to about 100 μm, or about 20 μm to about 100 μm, and preferably about 45 μm. Similarly, the boride source powder can have a particle size from about 1 μm to about 10 μm, and preferably about 2 μm. Thus, in some embodiments, the titanium source powder can have a particle size significantly greater than the particle size of the boride source powder. Typically, the titanium source powder can have a particle size from about 5 to about 100 times that of the boride source powder, and most often from about 8 to about 15 times. Additionally, the titanium source powder can have a size ratio of titanium source powder particle size to boride source particle size from about 15:1 to about 30:1. However, in other embodiments, the sizes of the titanium source and boride source powders can be approximately equal when a densifier is also included.

Additives can also be included to form the powder precursor. However, such additives must be carefully chosen so as to not interfere with whisker growth or consolidation. The addition of densifier powders can help to decrease porosity of the final product and can contribute to the porosity reduction effect of multimodal packing described herein. Densifier powders can have particle sizes which are consistent with the above discussion regarding packing. In some embodiments, a densifier can be used with or without trimodal packing Therefore, in some embodiments the powder precursor can comprise or consist essentially of a titanium source powder, a boride source powder, and a densifier. In one aspect, the powder precursor can comprise or consist essentially of titanium, titanium diboride, and a densifier. As such, in one aspect, the resulting products can thus consist essentially of titanium, titanium monoboride whiskers, and a minor amount of the densifier incorporated into the whisker structure and a minor amount dissolved in titanium matrix. The densifier can be any material which acts to increase density and preferably without interfering with whisker growth. Further, the densifier preferably has a melting point below the process temperatures used for whisker growth. Also, a suitable densifier will not form borides more readily than TiB at the process temperatures and pressures. In another alternative aspect, a metal or alloy densifier preferably forms a eutectic liquid with titanium and/or boron. In one embodiment, the densifier can include, or consist essentially of, a metal, a combination of metals, or an alloy which forms a eutectic liquid at temperatures from about 600° C. to about 1300° C. Suitable specific alloys beyond those discussed herein can be identified by examining the phase diagrams and relative reactivity of elements with titanium and/or boron. For example, a powder densifier such as pure Fe, pure Mo and/or Fe alloys such as Fe—Mo can be added as part of the powder precursor. Non-limiting examples of other potentially suitable densifiers includes elements such as Al, Ga, Sn, Mn, Cr, V, P, S, Fe, Mo either alone or in combination and alloys such as Fe—Mo, Fe—Cr, Fe—V, Fe—Sn, Fe—Ga, Fe—Mn, and combinations thereof. It has been found that Fe—Mo as an additive can allow densification of the nanostructured TiB in a much shorter time. For example, addition of about 10 wt % Fe—Mo powders can help reduce the process time from about 2 hours to about 30 minutes or less at the process temperature discussed herein. Amounts of Fe—Mo in the range of 5-20 wt % can be added to the powder precursor without causing any significant change in the amount of TiB, or its structure or morphology in the processed material. A currently preferred Fe—Mo powder composition is Fe: 40% and Mo: 60% by weight, although other Fe—Mo compositions can also be suitable. Generally, from about 0.5 wt % to about 20 wt % of a densifier can be added, and in other cases about 5 wt % to 12 wt %.

Without being bound to any particular theory, there appears to be no competitive growth of FeB or MoB because temperature and pressure conditions are not suitable for the formation of FeB and MoB, and titanium is more reactive with boron as compared to that of Fe/Mo with boron under the desired process conditions. The atoms of Fe and Mo from the Fe—Mo additive are atomically incorporated inside the TiB crystal lattice and in the residual titanium if any. Thus, there is substantially no change in the structure and morphology of the TiB microstructured and/or nanostructured material, because Fe and Mo atoms, after helping to decrease the porosity, are absorbed into the material itself. This absorption takes place in a way that does not change the basic crystal structure of TiB. Specifically, Fe and Mo can form bonds with B atoms in a way that is similar to the formation of bonds between Ti and B inside the TiB crystal structure. The amount of Fe—Mo added can be sufficiently small so as to not cause substantial change in the mechanical properties of the final product. The mechanism by which Fe—Mo additive decreases the porosity is by forming a liquid phase near the process temperature. The melting temperature of the alloy of composition: Ti-34 wt % Fe is about 1070° C. It appears that the Fe from the Fe—Mo additive, by reacting with the titanium powder, leads to the formation of a liquid of this alloy (Ti-34 wt % Fe) composition along the interstices of the powders. In the case of Fe—Mo addition, a liquid is formed anywhere from 900° C. to 1300° C., depending on the local dilution of Fe—Mo with the titanium and boron atoms. The liquid, formed shortly before the process temperature is reached, allows a quicker dissolution and diffusion of B from titanium diboride particles and the continued transport of B to the titanium powder sites to form the nanostructured TiB. Typically, the densifier and other optional additives can shorten the time for the formation of a fully dense product. In a variant of this process, separate densifier powders, e.g. Fe and Mo elemental powders, can be used although care should be taken to avoid non-uniform titanium monoboride whisker thickness in the monolithic material.

In one alternative aspect of the present invention, the powder precursor can have a multimodal size distribution. Typically, the powder precursor can have a bimodal size distribution although a trimodal size distribution can also be suitable.

Titanium Boride Articles with Trimodal Source Powders

In another embodiment, the powder precursor can include a multimodal distribution of particle sizes formed of a quantity of titanium source powder, a quantity of densifier powder, and a quantity boride source powder in a size ratio of X:Y:Z, respectively. The particular choice of X, Y and Z can depend on the desired final product. However, as a general guideline, X can be from about 20 to about 100, Y can be from about 2 to about 15, and Z can be about 0.5 to about 55.

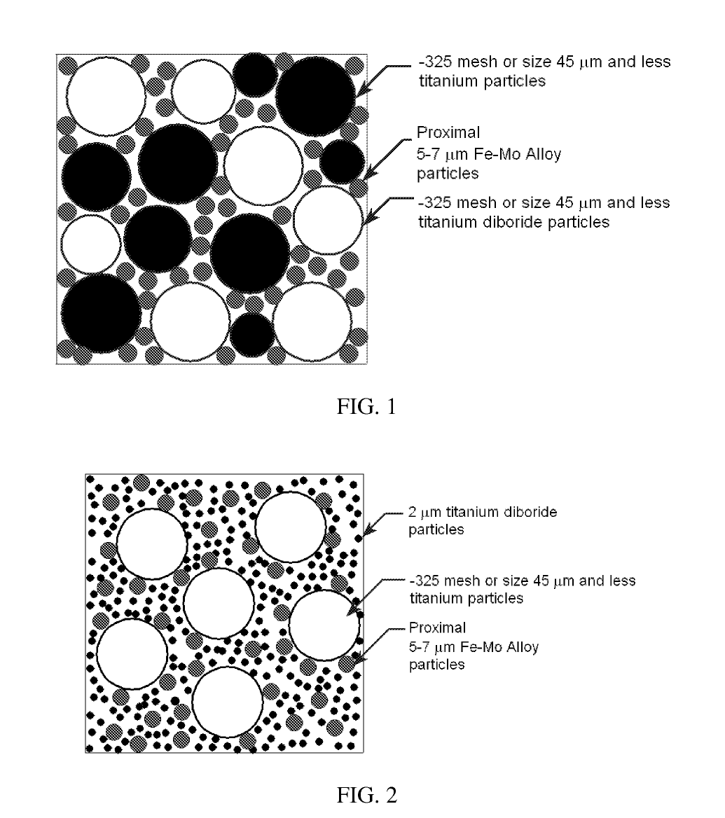

In one currently preferred embodiment, the titanium source powder can be titanium and the boride source powder can be titanium diboride with sizes that are substantially the same. FIG. 1 illustrates one example of a packing distribution in accordance with this embodiment where the titanium and titanium diboride particles are approximately the same size. This can allow for the use of readily available particle sizes without the need for milling or sizing. The corresponding size of the densifier in these embodiments can be substantially smaller than that of both the titanium and titanium diboride powders. Typically, the ratio of X:Y can be from about 5:1 to about 20:1, about 5:1 to about 8:1, and even about 6:1 to 7:1. In one aspect, Z and X can be substantially the same such that the multimodal distribution is a bimodal distribution.

In another embodiment, the multimodal distribution can be a trimodal distribution where X is from about 35 to about 55, Y is from about 2 to about 15, and Z is from about 1 to about 5. Currently, the most preferred distribution in this embodiment is X of about 45, Y of about 5 to 7, and Z of about 2 which corresponds to a relatively high theoretical packing density. FIG. 2 illustrates a packing arrangement for such a trimodal distribution where each of the titanium, titanium diboride, and densifier powder have distinct and different size ranges and the densifier is an intermediate size range between that of the titanium and titanium diboride powders.

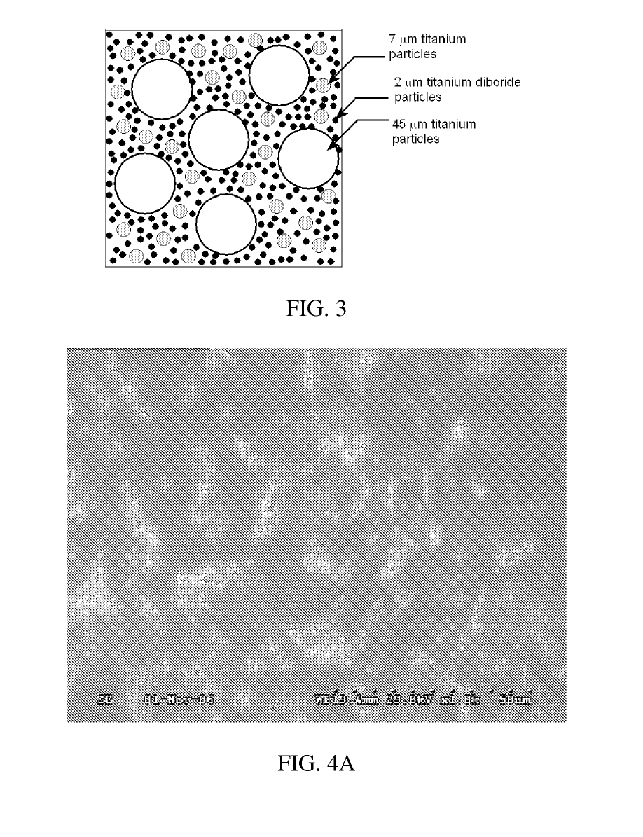

In another alternative embodiment, the titanium source powder can include titanium source powders having at least two different sizes. In one aspect, the titanium source powder can have two different sizes. FIG. 3 provides an illustration of a packing arrangement having two different sizes of titanium source powders that are titanium powders. Although additional quantities of titanium source powder and/or boride source powder at different sizes can be added to the titanium powder, only minor improvement in results is achieved. One tri-modal size distribution that has proven effective includes a first quantity of titanium source powder, a second quantity of titanium source powder, and a boride source powder in a size ratio of X:Y:Z, respectively, where X is from about 35 to about 55, Y is from about 2 to about 15, and Z is from about 1 to about 5. Preferably, X can be from about 40 to about 50 and Y from about 5 to about 10, and most preferably a ratio of 45:7:2 can be used.

As mentioned above, providing a tri-modal size distribution is one factor which allows the production of nanostructured and/or microstructured titanium monoboride monolithic material in accordance with the present invention. Although the invention is not specifically limited thereto, it can be difficult to achieve uniform titanium monoboride growth and substantial elimination of titanium diboride using bi-modal size distributions (i.e. titanium source powder and boride source powder each of a single average size). However, as mentioned herein, a bimodal distribution can be preferred when a densifier powder is included. At least part of the reason for this is the influence of packing density on the ability of titanium and boron to migrate and react. Thus, the formation of the powder precursor is a careful balance of packing density and access of boron to titanium to form titanium boride whiskers, especially for titanium monoboride whiskers. Access of boron to titanium is at least partially governed by the relative proportions of titanium and boride, as well as the relative particle sizes.

Packing Density Considerations

In tri-modal mixtures of solid state powders, the packing density is a strong function of the particle size ratios of the three powders. A proper selection of the powder sizes, to achieve maximum packing before sintering, is important in achieving high density, complete reaction, and uniform distribution of the microstructure and/or nanostructure in the TiB monolithic material. The mathematical formula, given in R. M. German, Powder Packing Characteristics, Published by Metal Powder Industries Federation, Princeton, N.J., 1994, p. 183, which is incorporated herein by reference, for powder-packing density (f) for a generic tri-modal powder, is given in Equation 1.

f=0.951−0.098A₁+0.098A₂−0.198A₁A₂ (1)

where

$${A}_{1} = exp ( - 0.201 \frac{{D}_{L}}{{D}_{M}} ) , {A}_{2} = exp ( - 0.201 \frac{{D}_{M}}{{D}_{S}} ) ,$$

and D_{S}, D_{M} and D_{L}, are the diameters of the small, medium and the large particles, respectively. According to Equation 1, for tri-modal powder mixtures, the maximum possible packing density attainable in the present tri-modal packing is about 92-93%, which is quite high compared to conventional powder processing in industrial operations that use mostly mono-sized powders. For example, one embodiment of the tri-modal mixtures used in the present invention has a particle size ratio of 45:7:2 (large to medium to small) which is very close to the theoretical maximum size ratio of 49:7:1, for obtaining a maximum packing density. This tri-modally packed powder configuration has an initial packing density that is quite close to the ideal packing density. The maximization of powder packing density is one important factor in achieving a full densification, complete reaction, absence of remnant unreacted TiB₂ particles, and uniform distribution of the microstructure and/or nanostructure in the present TiB monolithic material. Additional sized powders can also be included, for example, by having a plurality of powder sizes for the titanium source, boride source, and/or the densifier. However, this also increases complexity of the process.

FIGS. 1 through 3 illustrate various aspects of particle packing and the particle-surrounding-mechanism that can be considered in choosing the multi-modal powder packing to manufacture the present microstructured and/or nanostructured monolithic material. When the present tri-modal powders are blended thoroughly, both the large (e.g. 45 micron) as well as small size (e.g. 7 micron) titanium source and/or densifier powders will be completely surrounded by smaller boride source particles. This spatial arrangement enables uniform contact between titanium source and boride source particles, allowing uniform reaction and formation of titanium boride whiskers. This distribution of particles can also be important to have complete reaction and prevent any residual TiB₂ particles, if desired. Without being bound to any particular theory, it is thought that the medium size titanium particles will act as the genesis of whisker growth and the larger titanium source and smaller boride source particles will act dominantly as raw material sources from which material diffuses toward growth areas. Additionally, the medium size titanium source particles allow for increased packing density above that possible using a bi-modal size distribution. In one aspect of the present invention, the tri-modal size distribution can be determined by optimizing packing density using Equation 1 to within about 15% of the theoretical maximum packing density, or even within about 5%.

Referring again to FIG. 1, it is noted that even though the powder packing arrangement is not optimized through the use of a trimodal distribution, the densifier such as Fe—Mo can still facilitate production of a dense and strong microstructured and/or nanostructured titanium boride compound after reaction. In particular, the densifier particles are proximal to almost all of the titanium source and boride source particles. One role of the Fe—Mo densifier powder is to produce a liquid phase around 900° C. which is maintained at high temperatures. This results in a liquid-bridge between a titanium source particle and neighboring boride source particles, enabling faster reaction. The liquid phase can allow faster diffusion of titanium and boron atoms and helps convert the material to microstructured and/or nanostructured titanium boride compounds quickly, eliminating the need for strict trimodal packing. The densifier thus acts as a densifying agent as well as an activating agent to obtain dense microstructured and/or nanostructured titanium boride jewelry articles of the present invention. Final densities greater than 99% of theoretical density can be achieved. Although porosity can vary depending on the particular precursor powder composition and process conditions, typical porosities (i.e. void fraction) of the final article can range from about 0.005 to about 0.05 and preferably from about 0.01 to about 0.1.

General Manufacturing Approach

The titanium source powder, boride source powder, and optional densifier powders can then be blended to obtain a substantially homogeneous powder mixture. This can be accomplished by mixing using a high shear mixer, ball mill or rotary blender with steel balls, or the like. The powder mixture can be pressed or consolidated to form the powder precursor to reduce porosity. Although the specific powder precursor can vary in properties, typically, the precursor can have a packing density from about 88% to about 95%, and preferably about 90%.

Almost any suitable commercial source can be used to obtain the above powders. Alternatively, the powders can be formed using any number of powder synthesis processes. However, regardless of the commercial source of such powders, the powders typically include nominal amounts of impurities such as O, N, C, Fe, Zr, H, and the like. Some of these impurities can be removed by baking the powders in vacuum or other such decontamination treatments. Typically, such impurities present in an amount less than about 1% of the total weight (preferably less than about 0.8% total) do not significantly affect ultimate performance of the microstructured and/or nanostructured titanium boride jewelry articles.

The powder precursor can then be maintained under a temperature and pressure (for example in a hot press or hot-isostatic press) sufficient to grow titanium boride whiskers, e.g., titanium monoboride whiskers. As a general guideline, the specific process temperature strongly affects the shape and diameter of the whiskers. In accordance with the present invention, the process temperature can be from about 900° C. to about 1400° C., about 1200° C. to about 1400° C., and preferably from about 1250° C. to about 1350° C. In one aspect where the titanium source powder is about 45 μm and the boride source powder, e.g., titanium diboride, is about 2 μm, the process temperature can be about 1300° C. Similarly, the pressure can range from about 5 MPa to about 50 MPa, about 20 MPa to about 30 MPa, about 26 MPa to about 30 MPa, and preferably about 28 MPa. In an alternative aspect, the tri-modal packing of powders with densifier can allow a process temperature down to about 1000° C.

The powder precursor can be heated under pressure and maintained thereat for a time which is sufficient to form titanium boride whiskers having the desired microstructure and/or nanostructure. Similarly, process time can influence whisker length and the thickness. Increasing process times can also result in a thickening of the whiskers. Typically, the process time can range from about one and a half to about three hours, and preferably about two hours. However, this process time can vary depending on the particle size, pressure, and densifier content.

Additionally, the powdered precursor can be heated to the appropriate process temperature at a rate of about 30° C./minute. Those skilled in the art will recognize, however, that this is merely a guideline and that temperatures and times outside those indicated may also be used to achieve the desired nanostructure.

As an additional consideration in designing the process to achieve the desired microstructure and/or nanostructure, the particle size of each constituent can affect the process temperature and process time needed to achieve the desired microstructure and/or nanostructure and composition. Incorrect performance and/or determination of the process temperature or time based on a given powder precursor can result in unacceptable products. For example, process times in excess of the appropriate time can result in the titanium boride whiskers to thicken or grow together to form solid portions such that the whisker microstructure and/or nanostructure is lost. Conversely, excessively short process times can leave the whiskers insufficiently interconnected and further allow residual boride source compound to remain in the matrix. An inappropriate temperature can also prevent the significant formation of high volume contents of titanium boride whiskers. The necessary process time and temperatures can be determined based on calculations which take these variables into account.

For example, on the basis of diffusion data, the time needed to form TiB whisker phases by the reaction between titanium and TiB₂ powders can be determined. The growth of TiB phase follows a parabolic relationship described in Equation 2.

x=k\sqrt{t} (2)

where x is the length of the whiskers (e.g., titanium boride microstructure and/or titanium boride nanostructure), k is the growth rate, and t is the process time. The temperature dependence of TiB whisker growth rate can be expressed as using Equation 3.

$$k = {k}_{0} exp ( - \frac{{Q}_{k}}{2 RT} ) \qquad ( 3 )$$

where k₀ is a constant (experimentally determined frequency factor), Qₖ is the activation energy for growth (e.g., microstructure and/or nanostructure growth), T is the temperature, and R is the universal gas constant (i.e. 82.05 cm³ atm/K/mol). The values of k₀ and Qₖ were found to be 17.07×10⁻⁴ m/√sec and 190.3 kJ/mole in Z. Fan, Z. X. Guo, and B. Cantor: Composites, 1997, vol. 28A, pp. 131-140, which is incorporated herein by reference. From these values, the computed k values at 1300° C. and 1100° C. are 40.96×10⁻⁸ m/√sec and 118.2×10⁻⁸ m/√sec, respectively. From these data, the estimated lengths of the TiB whiskers that can form after 2 hrs, assuming direct Ti—TiB₂ contact, are about 99 μm at 1300° C. and 34 μm at 1100° C. However, experiments reveal that the growth of TiB substantially ceases after reaching length values of about 40-45 microns and 10-15 microns for the powder mixtures pressed at 1300° C. and 1100° C., respectively. These values are roughly half of the estimated values. This suggests that TiB growth is fully complete prior to the theoretical two hour process time and that the present TiB material can be formed in about one hour process time, to get nearly the same microstructures. However, shorter times can result in remnant TiB₂ which can disrupt the uniformity of a desired nanostructure; therefore, preferably, process times of up to about two hours can be used in order to ensure that all TiB₂ will be fully converted into TiB. As a general guideline, process times from about half the theoretical process time to about 1.2 times the theoretical process time are preferred. However, longer process times up to 24 hours do not adversely affect the desired nanostructure and the properties, and hence can be used as well.

In one aspect, upon taking the powder precursor to the desired temperature and pressure, the titanium powder reacts with titanium diboride to form a titanium monoboride as indicated by Equation 4.

Ti+TiB₂→2TiB (4)

The pressure and temperature can then be reduced to allow the titanium monoboride article to cool. A monolithic titanium monoboride can thus be recovered which is substantially free of titanium diboride. Further, the titanium monoboride whiskers can be present at a volume content greater than about 80% in accordance with the principles of the present invention.

Depending on the powder precursor composition and the process conditions used in forming the titanium boride jewelry articles, e.g., titanium monoboride articles, of the present invention, the flexure strength can generally range from about 500 MPa to about 990 MPa, and can be from about 500 MPa to about 950 MPa, or even from about 650 MPa to about 950 MPa. The hardness of the titanium boride compounds, e.g., titanium monoboride, can range from 1400 Kg/mm² to about 2000 Kg/mm², and in some cases about 1600 Kg/mm² to 1800 Kg/mm², measured by the Vickers technique. In Moh's hardness scale that is often used in the jewelry industry, the hardness values of titanium boride materials discussed in the present invention can range form 8.5 to 9.5. For titanium monoboride materials with 90-99% TiB by volume, the Moh's hardness can be about 9.0-9.2. The method and materials used to form the titanium boride articles can be adjusted to tailor strength and hardness to a particular use or application.

Once the main body is complete it can be recovered from the high temperature device. Finishing can entail surface finishing and/or coupling the main body to other pieces or ornaments. For example, standard grinding and polishing techniques such as diamond polishing, abrasive polishing, and the like can be used to achieve a mirror finish. Further, recesses or other features can be machined into the main body in order to provide attachment for clasps, retaining members, precious stones, inlaid metals, or other ornamentation. The main body can also optionally be coupled to other parts such as when coupling multiple links to form a chain, bracelet or watch band.

The following examples illustrate exemplary embodiments of the invention. However, it is to be understood that the following is only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following example provides further detail in connection with what is presently deemed to be a practical embodiment of the invention.

### EXAMPLES

### Example 1

### Preparation

Several different proportions of powder mixtures of titanium diboride (TiB₂) powder, titanium (Ti) powder and an iron-molybdenum alloy (FeMo) powder were used to synthesize the varied nanostructured monolithic titanium boride (TiB) materials. FeMo alloy powder is employed as the densifier in all of the mixtures.

Table 1 provides a compilation of the Ti—TiB₂—FeMo compositions (wt. %) that have been synthesized in the laboratory. All the compositions contain 15 grams of the densifier, Fe—Mo, but with different proportions of Ti and TiB₂ powders to identify correlations of various properties.

TABLE 1

| Compositions | |
|---|---|
| Ti—TiB₂—FeMo (grams) | Sample Identity |
| 135-159-15 | SM 19 |
| 140-159-15 | SM 16 |
| 145-159-15 | SM 18 |
| 152-159-15 | SM 12 |
| 157-159-15 | SM 11 |
| 162-159-15 | SM 9 |

The powder mixture uses titanium powders of average size of −325 mesh (particle sizes including 45 μm and below and chemical composition in wt. %: 0.23 O, 0.02 N, 0.01 C, 0.04 Fe, and 0.024H; balance Ti), titanium diboride powders of average size 2 μm (chemical composition in wt. %: 30.3 B, 0.67 Zr, 0.01 C, 0.04 Fe, and 0.024H, and balance Ti) and FeMo alloy powders of size 5-7 μm. The chemical composition of FeMo alloy powder was: Fe-59.8 wt. % Mo. Similar densifier compositions such as Fe-50Mo and Fe-70Mo can also be used with some modification to process temperature and time. Use of this combination of powders also results in a nearly trimodal powder packing arrangement, and places much less stringent requirements on powders. For example, the titanium powders of −325 mesh, which are commercially readily available can be used without resorting to two different sized titanium powders.

The reaction sintering process was performed in a single heating and pressure step. The blended and packed powder mixture was placed in a 30 ton vacuum hot press in a graphite die. The blended powders were loaded into the die with GRAFOIL sheets as liners along the die walls. The hot press chamber was then evacuated using a rotary pump and refilled with commercially pure argon. The evacuation and refilling procedure was repeated three times to remove any residual O₂ and N₂ in the chamber. The die assembly with the powder was then heated at a rate of 30° C./min to 1300° C. Upon reaching 1300° C., a pressure of about 28 MPa was applied and held for two hours at this temperature. Small changes in temperature (e.g. +/−50° C.) and pressure (+/−2 MPa) are not likely to change the final result greatly, although care should be taken to eliminate residual titanium diboride. The die was subsequently cooled slowly to room temperature and a dense, monolithic TiB material was ejected out of the die. The material was ready for preparation into desired jewelry components without any further treatment or processing. This material can be machined via electro-discharge machining (EDM) processes.

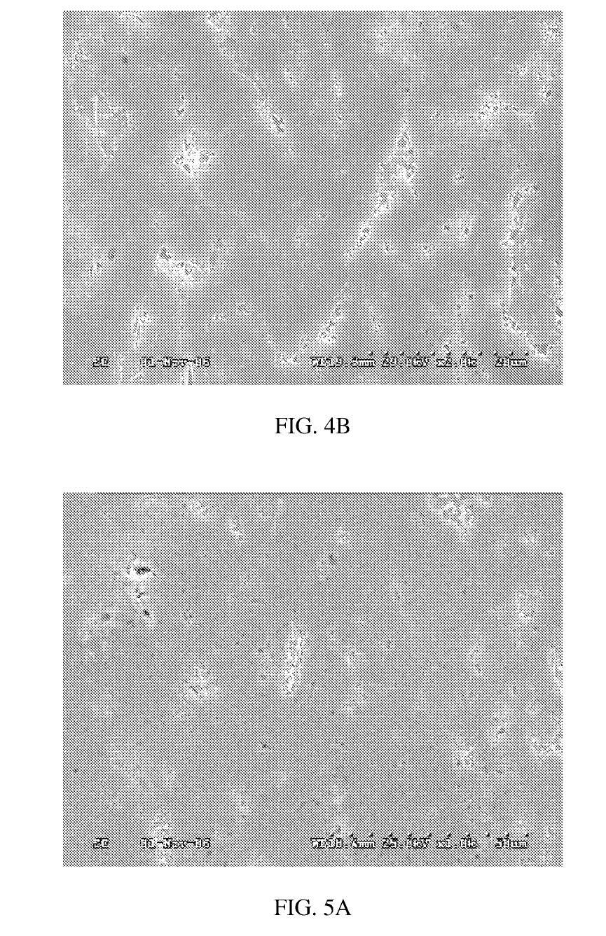

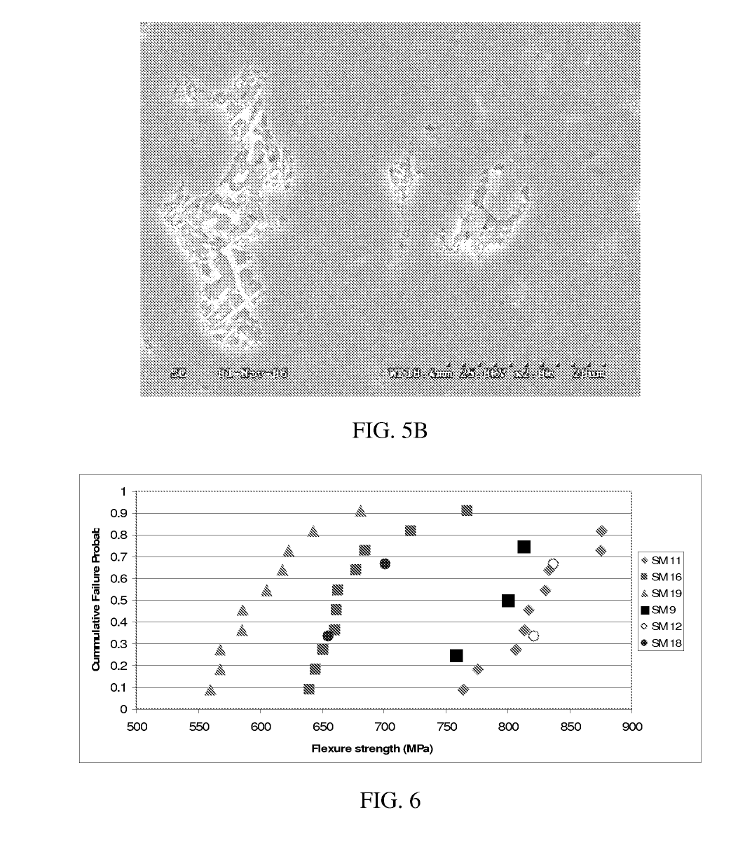

FIGS. 4A and 4B are SEM pictures of microstructures in the nanostructured titanium boride made with a powder composition of Ti—TiB₂—FeMo: (SM 11 in Table 1) at 1000× and 2000×, respectively. FIGS. 5A and 5B are SEM pictures of microstructures of nanostructured titanium boride made with a powder composition of Ti—TiB₂—FeMo: (SM 19 in Table 1) at 1000× and 2000×, respectively. These pictures indicate the nanostructure, the high degree of densification and intergrowth of the titanium monoboride whiskers.

One advantage of this choice of materials is that the use of FeMo as a densifier allows for less rigorous titanium particle size choice, but uses readily obtainable titanium and titanium diboride powders. This is advantageous, because detailed particle size classification can be avoided and the overall cost of the process can be reduced. One role of the Fe—Mo alloy powder is to produce a liquid phase around 900° C. which is maintained at higher temperatures, even beyond the typical hot pressing temperature of 1350° C. Without being bound to any particular theory, Fe—Mo particles appear to act as “proximal” particles primarily adjacent to titanium particles, thus helping in the formation of the liquid phase. The liquid phase enables faster inter-diffusion of titanium and boron atoms and helps convert the material to nanostructured titanium boride quickly, eliminating the need for trimodal packing.

Evaluation and Testing

FIG. 6 illustrates the distribution of flexural strengths for several nanostructured titanium boride materials made with the powder compositions in Table 1. All of the tested samples provided high strength greater than 550 MPa, although the highest strength was achieved with the powder composition of SM 11.

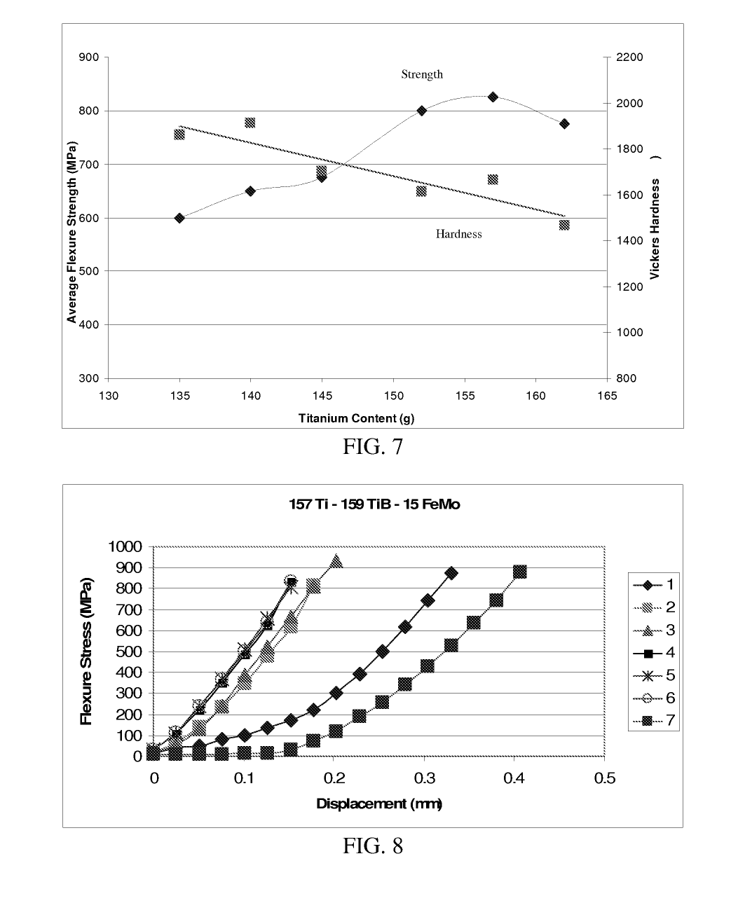

FIG. 7 illustrates the average mechanical properties of the nanostructured titanium boride (TiB) made with different proportions of titanium powder (−325 mesh) and with 159 g of 2 μm TiB₂ powder and 15 g of 5-7 μm Fe—Mo powder (Table 1). Average flexural strength levels vary from about 600 MPa to about 850 MPa as the titanium powder content is varied from 135 g to 157 g. The highest average strength (about 850 MPa) is achieved in the Ti—TiB₂—FeMo composition: 157-159-15 g (SM 11). The hardness varies from about 2000 VHN to about 1500 VHN as the titanium powder content is varied from 135 g to 162 g. It can be seen that the strength and hardness levels vary slightly and inversely, offering some room to tailor the properties of the material for a given application.

FIG. 8 shows a graph of load-displacement traces for the highest strength nanostructured titanium boride made from the powder composition of SM 11. The numbers refer to repeated tests. The displacements at fracture vary from 0.15 to 0.4 mm because of the variations in the initial contact conditions (compliant or rigid) of the loading points of the fixture in which the tests were conducted. Such variations are routine and do not reflect on the performance of the material.

### Example 2

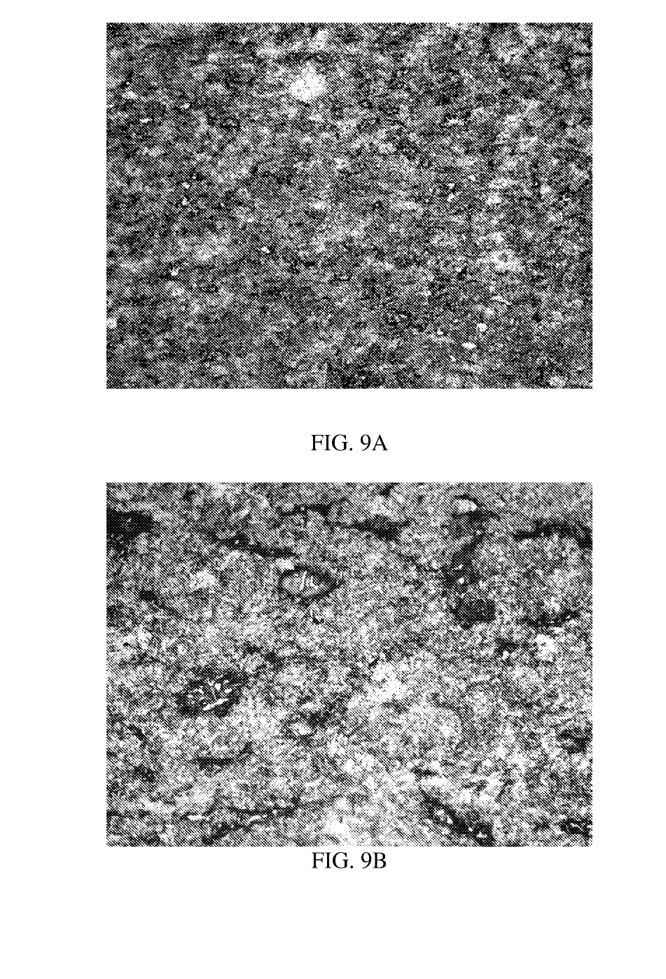

A powder mixture was made of titanium diboride (TiB₂) powder, titanium (Ti) powder and an iron-molybdenum alloy (Fe—Mo) powder to synthesize the nanostructured monolithic titanium boride (TiB). The same powders were used as in Example 1, except both the titanium and the titanium diboride powders were −325 mesh (sizes of 45 μm and below including different proportions of particle sizes down to about 1 μm). A composition of Ti—TiB₂—FeMo: 157-159-15 (grams) was used to synthesize the material under the same conditions as in Example 1. The resulting material was microstructurally quite similar to the material made in Example 1, and is expected to exhibit similar properties. FIGS. 9A and 9B are optical pictures (magnified at 200× and 1000×, respectively) of the microstructures for the synthesized material which illustrate more clearly the network of whiskers which comprise the bulk of the material.

### Example 3

### Preparation

A nanostructured titanium monoboride was manufactured from a powder mixture with a tri-modal distribution of Ti and TiB₂ powders. The relative powder sizes were important in obtaining the desired nanostructure in the final TiB material. A bi-modal titanium powder mixture having an average size of 45 μm and 7 μm and a composition of (wt. %) 0.23 O, 0.02 N, 0.01 C, 0.04 Fe, and 0.024H and titanium diboride powders having an average size of 2 μm and a composition of (wt. %) 30.3 B, 0.67 Zr, 0.01 C, 0.04 Fe, and 0.024H were provided. The titanium powder and titanium diboride powders were mixed together at 49 wt % Ti (41±2 wt % of 45 μm size and 9±1 wt % of 7 μm size powder) and 51 wt % TiB₂. The powders were then thoroughly blended for 24 hours in a rotary blender with steel balls to ensure homogeneity of the mixture. These powders have a size ratio of 45:7:2, and a packing density of about 90% in the blended state, which was found to be important in achieving the desired nanostructure.

The reaction sintering process was performed in a single heating and pressure step as outlined in Example 1. The blended powders were loaded in a graphite die with GRAFOIL sheets as liners along the die walls. The hot press chamber containing the die assembly was then evacuated using a rotary pump and refilled with commercially pure argon. The evacuation and refilling procedure was repeated three times to remove any residual O₂ and N₂ in the chamber. The die assembly with the powder was then heated at a rate of 30° C./min to 1300° C. to form the TiB whiskers. Upon reaching 1300° C., a pressure of about 28 MPa was applied and held for two hours at this temperature. Small changes in temperature (e.g. +/−50° C.) and pressure (+/−2 MPa) are not likely to change the final result greatly, although care should be taken to eliminate residual titanium diboride. The die was subsequently cooled slowly to room temperature and a dense, monolithic TiB material was ejected out of the die. The material was ready for preparation into desired components without any further treatment or processing. This material is particularly suited to machining via electro-discharge machining (EDM) processes.

Evaluation and Testing

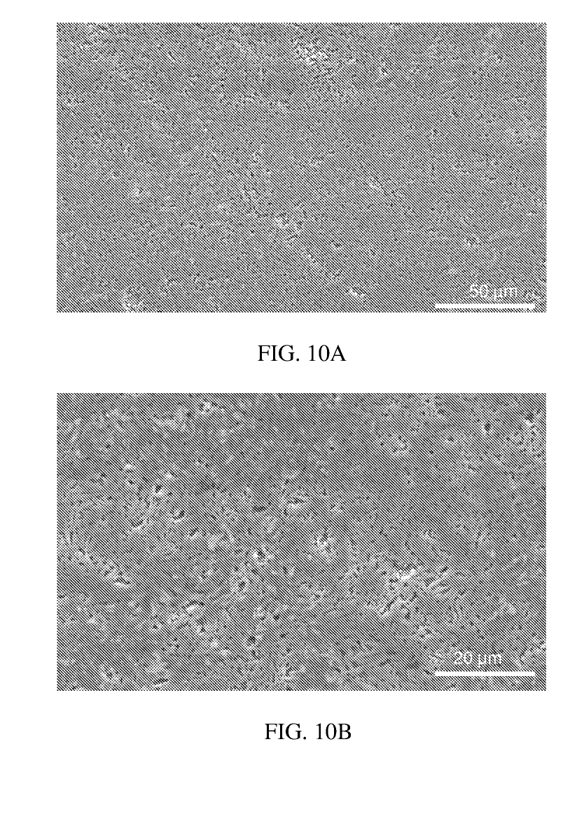

FIGS. 10A and 10B illustrate the nanostructures of the titanium monoboride material. The micrographs were taken in a scanning electron microscope after etching with Kroll's reagent. The microstructure consists of bundles of extremely thin-sized whiskers. The individual rod-like features are the nanostructured TiB whiskers, although the individual rods are not entirely distinguishable due to the limitations of resolution in the scanning electron microscope. The volume fraction of titanium monoboride, estimated from X-ray diffraction varied from 86-95%, with the reminder being Ti.

The rod-like features are the TiB whiskers that formed as a result of the reaction between Ti and TiB₂ particles. The darker regions represent the residual titanium (anywhere between 5-9%, estimated from X-ray diffraction that acts as a binder of the TiB whiskers.

Four-point flexural strength tests were conducted to evaluate mechanical properties. The size of the samples was approximately 25 mm×6 mm×5 mm. The samples were cut from the reaction sintered plate by EDM machining. Subsequently, the samples were ground using 220 grit diamond wheel to remove surface layers about 0.25 mm depth from the EDM surface. The samples were polished further using a 35 micron diamond disk, followed by fine polishing through 10, 6 and 3 micron suspensions in sequence. For comparison, specimens from commercial TiB₂ plate were also cut, prepared and tested in an identical manner.

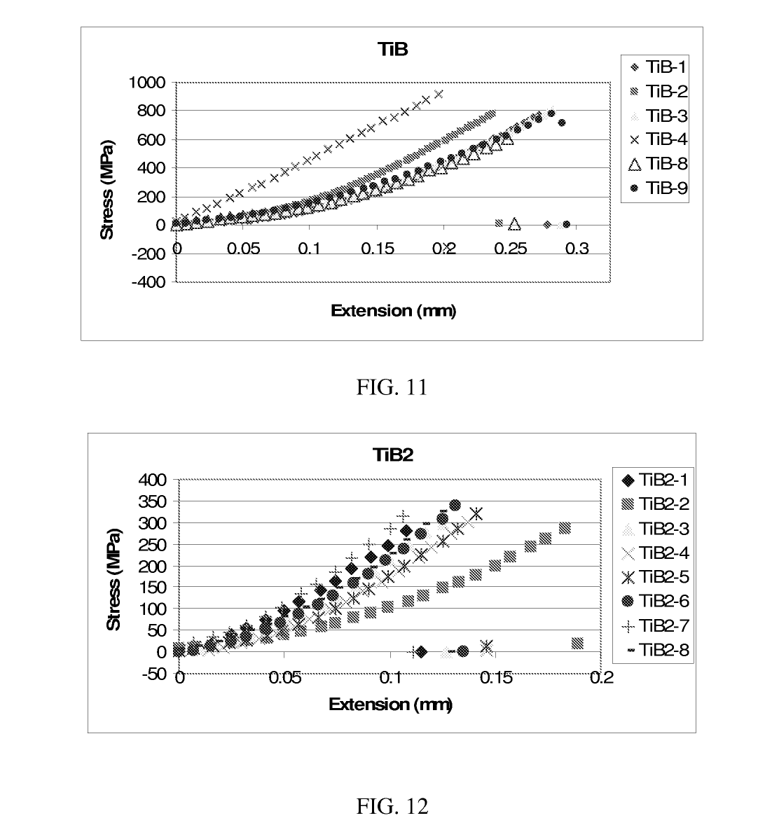

FIG. 11 presents the stress-displacement plots of tests of several specimens from the nanostructured titanium monoboride material. FIG. 12 presents the similar test results for the commercial TiB₂ material. It can be seen that the ultimate failure stresses for the specimens of nanostructured TiB are about two to three times higher than the corresponding loads for the TiB₂ specimens.

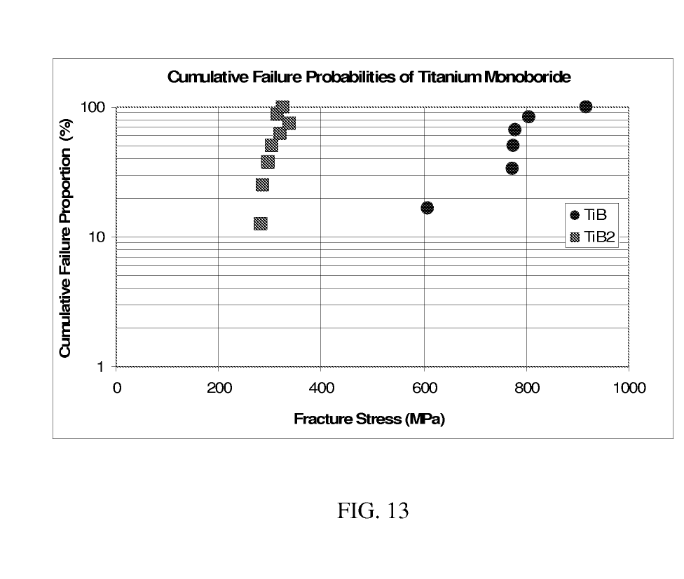

The flexural strength levels for both materials are plotted in the form of a cumulative failure probability distribution in FIG. 13. Based on these results, the flexure strength levels of nanostructured TiB material is, on average, about three times higher than the commercial TiB₂ material. The nanostructure refinement achieved in the titanium monoboride articles of the present invention, yielding a whisker-nanostructure makes the material much stronger than TiB₂. The grain size of TiB₂ used for comparison in FIG. 13, is in the range of 5-10 microns.

### Example 4

Silicon nitride is generally known to be the most abrasion/scratch resistant ceramic of all ceramics. A comparison of the abrasion resistance of a TiB nanostructured material with the silicon nitride has been made. Table II summarizes the properties of titanium monoboride nanostructured material against a well known silicon nitride ceramic (Cerbec Grade NDB-200; Saint-Gobain Ceramics, CT, USA). The mechanical properties that are important from a durability and reliability point of view are given. Overall, the mechanical properties of nanostructured TiB are quite comparable to that of silicon nitride. However, the TiB nanostructured material possesses a distinct advantage in abrasion resistance. In particular, with TiB, the volume of material lost in abrasive conditions is about ⅓ of that for silicon nitride in both wet and dry abrasive conditions, as determined from ASTM G99 abrasive wear testing. As such, the TiB nanostructured material can be about three times more wear/scratch resistance than silicon nitride.

The mechanical properties, in particular the abrasion test results show that TiB can be a highly abrasion/scratch resistant material when used to form jewelry articles. Further, the TiB nanostructured material is highly reflective and mirror-like when polished to the degree of finish common in jewelry making. This is a result of the electrically conductive nature of the TiB material. Most of the ceramics are not electrical conductors and as a result, do not offer highly reflective, mirror-like finish even when highly polished.

TABLE II

| | Nanocrystalline | Silicon |
|---|---|---|
| Property | TiB | Nitride* |
| Density (g/cc) | 4.5 | 3.16 |
| Modulus (GPa) | 370-425 | 320 |
| Hardness (Hv) | 1500-2200 | 1550 |
| Flex Strength (MPa) | 500-1000 | 900 |
| Fracture. Toughness (MPa✓m) | 5-6 | 5-6 |
| Finished appearance after diamond | Mirror-like finish | Dark gray |
| polishing | and reflectivity | |
| Volume of material lost during | 0.0001 | 0.0003 |
| abrasion in lubricated condition* | | |
| (cubic mm) | | |
| Friction in Lubricated condition* | 0.092 | 0.086 |
| Volume of material lost during | 0.02487 | 0.06618 |
| abrasion in dry condition** | | |
| (cubic mm) | | |
| Friction in dry condition** | 0.563 | 0.585 |

*Ball-on-disc abrasion test per ASTM G99 specification, with 6.35 mm balls run against Cerbec NBD-200 silicon nitride disk, 5 kg load, 0.1 m/sec sliding speed, 1000 m sliding distance, lubricated with mineral oil at room temperature
**Ball-on-disc abrasion test per ASTM G99 specification, with 6.35 mm balls run against Cerbec NBD-200 silicon nitride disk, 5 kg load, 0.1 m/sec sliding speed, 1000 m sliding distance, dry tests at room temperature and at atmospheric pressure

### Example 5

An alternate route to manufacture bulk micro structured and/or nanostructured titanium boride jewelry articles is to make a plastic or green preform that conforms to an approximate shape close to that of the jewelry article to be manufactured. The preform is then consolidated in a press to the substantial net shape by the application of pressure and temperature as described herein. In one aspect, the jewelry shape can include internal surfaces and forming the article can include providing a substantially incompressible preform mold about which at least a portion of a powder precursor is formed.

The preform is made by first blending the desired ratios of the component powders as described herein. To the powders added are a solvent, a binder, and a plasticizer. The solvent can be any organic solvent. Typical solvents include ethanol, methanol or acetone or any similar organic solvent. The binder can be any polymer. Typical binders include polyvinyl buterol, cellulose acetate, ethylene glycol or any such binders. The plasticizer can be any organic solvent, polymer, or mixture thereof having plasticizing abilities sufficient to allow molding or working into a desired shape without cracking or losing its shape. Typical plasticizers include glycerol, wax, or other such organics having such plasticizing abilities.

The proper ratios of the solvent (about 10-30 wt % of powder mixture), the binder (about 2-10 wt % of powder mixture) and the plasticizer (about 2-15 wt % of powder mixture) are first added to the powder mixture. For optimum preform properties, the desired binder+plasticizer combination should be kept between about 5-15 wt % of the powder. The mixture is then tumbled for 4 hours, followed by drying in air for a few hours. At this point, the powder is plastic and behaves like a putty or clay that can be molded into desired shapes.

The preform putty is then formed to an approximate shape that is desired, using a set of molding dies. The approximate shape can be an oversize, to allow for the shrinkage in the subsequent firing and consolidation processes. A variant of this shape-making process is to follow the injection molding practice used in the plastics manufacturing industry. Here, the binder+plasticizer combination can be so chosen to render the preform putty/clay viscous or flowable enough. This viscous putty can then be injected by pressure into the mold cavity having the desired shape.

The preform material shaped either conventionally or by injection molding is then fired in an oven, typically at temperatures of 200-250° C. for 1 hour under a vacuum of at least about 0.1 atm. This allows the burning out of the organics in the solvent, the binder, and the plasticizer. The preform is then strong and is able to retain the shape that can be handled without exerting too much handling force.

The shaped preform can then be reaction sintered either in a hot press or in a hot isostatic press (HIP) to start and complete the formation of microstructured and/or nanostructured titanium boride compound throughout the volume of the shape, by reaction consolidation. The typical pressure, temperature and time combinations recommended for reaction consolidation in the previous examples can also be used, although the required pressure, temperature and time for complete consolidation can be lower than that in the direct reaction consolidation process.

### Example 6

In an alternate method of consolidation, a laser beam can be used to promote the reaction and consolidation of the titanium boride microstructured and/or nanostructured jewelry article. The preforms made in Example 5 can be exposed to a laser radiation where the laser induced heating and the pressure from the pulses effectively reacts and sinter the component powders. Extremely fine nanostructured TiB whiskers may be formed by this method with a further improvement in the abrasion/scratch resistance of the surface of the material.

A variant of the laser process is to glaze the surface of titanium boride-rich jewelry article to impart increased abrasion/scratch resistance. The substrate of the jewelry can be an article composed of any volume fraction of titanium boride nanostructured and/or nanostructured material (usually 50% by volume or above), with the reminder being titanium matrix with the appropriate aforementioned alloying elements. Laser glazing/hardening of a titanium-matrix composite, consisting of dispersions of TiB phases and whiskers can cause melting and re-solidification of the surface layers, accompanied by an increase in the volume percentage of the titanium boride whiskers or phases. The whiskers or phases can have nano to micro-meter dimensions, depending on the laser power settings and the speed of the glazing process. This process results in an increase in hardness and resistance to wear of the treated surface layers by a factor of two (2× or 200%) and to a depth of a few millimeters from the surface over a comparable article that has not been laser hardened. In one aspect, the increase can be 3×, 5×, or even 10× a comparable article. A “comparable article” is one that is of the same composition and general shape as the original article but is not laser hardened such that a completely objective test can be performed to distinguish between the two articles. Laser glazing/hardening can be desirable to increase the scratch resistance of the jewelry article.

Laser input energies in the range of 2-200 KJ/m can be used to produce varying degree of depth of remelting and hardening of surface. Typical power required for this range is from 0.2-20 KW and laser traverse speeds in the range of 0.001-0.1 msec. Any titanium or titanium alloy with dispersed boride phases can be laser hardened, including the titanium borides disclosed herein. However, in one embodiment, the present articles can be most effectively hardened with a TiB and/or TiB₂ volume content greater than about 30%.

In one aspect, a method of doing laser glazing of jewelry surfaces to increase the resistance to abrasion and scratching can be to first to make jewelry to a close enough shape, by any of the methods discussed in this application. The surfaces where scratch resistance is required can then be exposed to laser of a prescribed power and for an optimum amount time, to re-melt and solidify the surfaces. For example, finger rings of close-enough shape can be held and rotated in a mandrel while being exposed to a laser radiation. The laser radiation can be moved laterally as desired to cover more surface area while melting the rotating surface, thus allowing complete coverage and melting of the outer surface of the ring, in a few rotations.

The laser surface treated jewelry, or any article of jewelry described herein, can be finished and polished by employing the standard polishing processes.

### Example 7

The process of isolating a shape required to manufacture a given type of jewelry can involve different cutting processes. A preferred method to shape the jewelry from the consolidated bulk material is electric-discharge-machining (EDM). By the use of either wire-EDM or tool-EDM, appropriate jewelry shapes can be carved out of the bulk TiB nanocrystalline material. The shapes can then be polished to the required finish and reflectivity.

Alternatively, spark erosion machining techniques can also be used. In this case, high voltage arcs are generated between the jewelry work piece and the tool to erode away the excess material and to bring the material into some shape.

In the process of bulk reactive consolidation, graphite dies in the hot press can be suitably designed to make a shape that approximately resembles the jewelry that is to be made. This will minimize the material removal requirement before final polishing and can be quite cost effective.

It is to be understood that the above-referenced arrangements are illustrative of the application for the principles of the present invention. Thus, while the present invention has been described above in connection with the exemplary embodiments of the invention, it will be apparent to those of ordinary skill in the art that numerous modifications and alternative arrangements can be made without departing from the principles and concepts of the invention as set forth in the claims.

What is claimed is:

1. An article of jewelry, including a main body consisting essentially of a titanium boride.

2. The article of claim 1, wherein the main body is monolithic titanium monoboride whiskers, said monolithic titanium monoboride whiskers being present at a volume content greater than about 80% of the main body and said article being substantially free of titanium diboride.

3. The article of claim 2, wherein the main body consists essentially of the monolithic titanium monoboride whiskers, titanium, and an optional densifier.

4. The article of claim 2, wherein the monolithic titanium monoboride whisker volume content is from about 88% to about 99%.

5. The article of claim 2, wherein the article of jewelry has a flexure strength from about 500 MPa to about 950 MPa.

6. The article of claim 1, wherein the titanium boride is a titanium diboride.

7. The article of claim 1, wherein the titanium boride is a quaternary boride or a ternary boride.

8. The article of claim 1, wherein the article of jewelry is selected from the group consisting of a ring, a necklace link, a watch casing, a bracelet link, a chain link, a pendant, combinations thereof.

9. The article of claim 1, wherein the surface of the article of jewelry has been laser treated such that the surface has a hardness of at least 200% than that of a comparable article that has not been laser treated.

10. An article of jewelry, including a main body comprising a titanium boride including titanium monoboride in a volume percent of about 30% to about 80%.

11. The article of claim 10, wherein the titanium boride further comprises a member selected from the group consisting of titanium diboride, titanium ternary boride, titanium quaternary boride, and mixtures thereof.

12. The article of claim 10, further comprising a non-titanium metal.

13. A method of forming an article of jewelry having a titanium boride microstructure, comprising the steps of:
a) forming a powder precursor including a titanium source powder and boride source powder, said powder precursor having a predetermined shape corresponding to a desired jewelry shape;
b) growing titanium boride microstructure from the powder precursor to form a titanium boride main body;
c) recovering the titanium boride main body; and
d) finishing the recovered titanium boride main body into the jewelry shape.

14. The method of claim 13, wherein the titanium boride microstructure is a titanium monoboride whisker nanostructure and wherein the titanium source powder is titanium powder and the boride source powder is titanium diboride powder, said powder precursor having a titanium powder to titanium diboride powder weight ratio from about 0.8:1 to about 1.2:1, and wherein the growing is performed under conditions sufficient to grow monolithic titanium monoboride whiskers from the powder precursor, said monolithic titanium monoboride whiskers being substantially free of titanium diboride and being present at a volume content greater than about 80%.

15. The method of claim 13, wherein the step of finishing includes electro-discharge machining or spark erosion of the titanium boride main body.

16. The method of claim 13, wherein the step of finishing includes at least one of grinding the titanium boride main body, polishing the titanium boride main body, and coupling ornamentation to the titanium boride main body.

17. The method of claim 13, wherein the step of forming includes forming a preform of the titanium source powder and the boride source powder having a solvent, a binder, and a plasticizer.

18. The method of claim 13, wherein the powder precursor has a titanium source powder to boride source powder weight ratio from about 0.8:1 to about 1.2:1

19. The method of claim 13, wherein the titanium source powder has a particle size from about 20 μm to about 100 μm and the boride source powder has a particle size from about 1 μm to about 10 μm.

20. The method of claim 13, wherein the titanium source powder has a size ratio of titanium source powder particle size to boride source particle size from about 15:1 to about 30:1.

21. The method of claim 13, wherein the powder precursor has a tri-modal size distribution such that the titanium source powder includes a first quantity of titanium source powder having a first average size and a second quantity of titanium source powder having a second average size.

22. The method of claim 13, wherein the powder precursor further includes a densifier.

23. The method of claim 13, wherein the jewelry shape is a ring, a necklace, a watch, a bracelet, a chain, a pendant, a link, a casing, parts thereof, combinations thereof, and sets thereof.

24. The method of claim 13, wherein the jewelry shape includes internal surfaces and the step of forming includes providing a substantially incompressible preform mold about which at least a portion of the powder precursor is formed.

25. The method of claim 13, further comprising laser hardening the surface of the jewelry article to a depth of at least one millimeter.
